(19) United States
(12) Patent Application Publication
(10) Pub. No.: US 2011/0029894 A1
(43) Pub. Date: Feb. 3, 2011

(54) SYSTEM AND METHOD FOR COMMUNICATING AMONG USERS OF A SET GROUP

(76) Inventor: Ira Eckstein, Rumson, NJ (US)

Correspondence Address: MALDJIAN & FALLON LLC, 36 BINGHAM AVENUE, RUMSON, NJ, 07760, US

(21) Appl. No.: 12/901,758

(22) Filed: Oct. 11, 2010

Related U.S. Application Data
(63) Continuation-in-part of application No. 12/378,791, filed on Feb. 20, 2009.
(60) Provisional application No. 61/250,124, filed on Oct. 9, 2009.
(60) Provisional application No. 61/264,237, filed on Nov. 24, 2009.

(51) Int. Cl. G06F 3/01; G06F 15/16

(52) U.S. Cl. 715/753

(57) ABSTRACT

In one embodiment, a system for communicating among members of a set group comprises an administrator hosting a computer network-accessible server; a plurality of users; a set of executable instructions stored on the server, the instructions for creating a virtual set group of users from the plurality of users based on a common interest in a real event at a venue; a data file comprising a graphic depiction of the venue, stored on the server, and downloadable to the computer device of each of the users; and at least one social user application, accessible by each of the users of the virtual set group, enabling the users of the virtual set group to interact; wherein the social user application utilizes the data file as an image file displayed on a screen of the computer device of each of the users of the set group.

### CROSS-REFERENCE TO RELATED APPLICATIONS

This application is a continuation-in-part of U.S. patent application Ser. No. 12/378,791, entitled “Ticket Trading Method,” filed Feb. 20, 2009, the disclosure of which is hereby incorporated by reference in its entirety. This application also claims priority to U.S. Provisional Patent Application Ser. No. 61/250,124, entitled “System and Method for Communicating Among Users of a Set Group,” filed Oct. 9, 2009, and this application also claims priority to U.S. Provisional Patent Application Ser. No. 61/264,237, entitled “System and Method for Communicating Among Users of a Set Group,” filed Nov. 24, 2009, the disclosures of which are hereby incorporated by reference in their entirety.

### BACKGROUND

1. Field of the Invention

Embodiments of the present disclosure generally relate to a system and method for communicating among users of a set group. More specifically, embodiments of the present invention relate to a system and method for communicating among users of a set group regarding common vacation locations, entertainment, sporting or other events, tickets, seats, or other related activities surrounding a particular venue, utilizing mobile communication devices.

2. Description of Related Art

Online and mobile social networking applications are becoming the most common way for people to stay connected with one another. Many of these applications are typically operated as managed services by application service providers and share several common characteristics, such as allowing users to create unique personal profiles that include basic information including identity, interests, profession, history, testimonials and information about their network. Commonly, users may map their relationship with other members, and may subsequently share information (multimedia data, posts, blogs, pictures, etc.) through the social networking application.

While such social networking applications are suitable for persons who are looking to stay in long-term contact with others and develop relationships, either virtual or real, such social networking applications do not allow for easy communication between users who share a common attribute, interest or physical proximity regarding a real event at a particular venue.

Accordingly, there is a need for a system and method for communicating among users of a set group, as disclosed herein.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a system-level network diagram of system for communicating among users of a set group in accordance with one embodiment of the present invention;

FIG. 2 depicts a block diagram of a general computer system, capable of being utilized in connection with the system depicted in FIG. 1, in accordance with another embodiment of the present invention;

FIG. 3 depicts a system level diagram for communication between a user and an administrator in accordance with one embodiment of the present invention;

FIG. 4 depicts a flowchart of a method for communicating among users of a set group in accordance with one embodiment of the present invention

FIG. 5 depicts a user's computer device showing an inquiry provided by the application software to facilitate the communication among users of a set group in accordance with one embodiment of the present invention;

FIG. 6 depicts a user's computer device showing a location-based inquiry provided by the application software to facilitate the communication among users of a set group in accordance with one embodiment of the present invention;

FIG. 7 depicts a user's computer device showing an graphical depiction of the location of users of a set group provided by the application software to facilitate the communication among users of a set group in accordance with one embodiment of the present invention;

FIG. 8 depicts a user's computer device showing a ticket trading interaction with the application software to facilitate the communication among users of a set group in accordance with one embodiment of the present invention;

FIG. 9 depicts a user's computer device showing a chatting interaction with other users of a set group using the application software to facilitate the communication among users of a set group in accordance with one embodiment of the present invention; and

FIG. 10 depicts a user's computer device showing a chatting interaction with other users of a set group using the application software to facilitate the communication among users of a set group in accordance with one embodiment of the present invention.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean “including but not limited to.” To facilitate understanding, like reference numerals have been used, where possible, to designate like elements common to the Figures.

### SUMMARY

Embodiments of the present disclosure generally relate to a system and method for communicating among users of a set group. More specifically, embodiments of the present invention relate to a system and method for communicating among users of a set group regarding common vacation locations, entertainment, sporting or other events, tickets, seats, or other related activities surrounding a particular venue, utilizing mobile communication devices.

In one embodiment, a system for communicating among members of a set group comprises an administrator comprising a server for hosting a computer network-accessible server; a plurality of users, each user comprising a computer device capable of accessing the server through the computer network; a set of executable instructions stored on the server, the instructions comprising steps in connection with creating a virtual set group of users from the plurality of users based on a common interest in a real event at a venue; a data file comprising a graphic depiction of the venue, stored on the server, and downloadable to the computer device of each of the users; and at least one social user application, accessible by each of the users of the virtual set group, enabling the users of the virtual set group to interact; wherein the social user application utilizes the data file as an image file displayed on a screen of the computer device of each of the users of the set group.

In another embodiment of the present invention, a method of communicating among members of a set group comprises providing a server for hosting a computer network-accessible server, the server comprising a memory for storing executable instructions in connection with creating a virtual set group of users from a plurality of users; allowing the plurality of users, each user comprising a computer device, to access the server through the computer network; creating the virtual set group of users from the plurality of users based on a common interest in a real event at a venue; enabling each of the virtual set group of users to download a data file from the server, the data file comprising a graphic depiction of the venue; and enabling the users of the virtual set group to interact through at least one social user application, accessible by each of the users of the virtual set group; wherein the social user application utilizes the data file as an image file displayed on a screen of the computer device of each of the users of the set group.

In yet another embodiment of the present invention, a system for communicating among members of a set group comprises an administrator comprising a server for hosting a computer network-accessible server; a plurality of users, each user comprising one of a mobile phone or a smart phone, capable of accessing the server through the computer network and comprising a global positioning chip capable of transmitting each user's location to the administrator; a set of executable instructions stored on the server, the instructions comprising steps in connection with creating a virtual set group of users from the plurality of users based on a common interest in a real event at a venue, including obtaining information from each of the plurality of users regarding location, subjective interests, or intentions of pre- or post-event activities; a data file comprising a graphical depiction of a seating chart of the venue, stored on the server, and downloadable to either the mobile phone or the smart phone of each of the users; and at least one social user application, accessible by each of the users of the virtual set group, enabling the users of the virtual set group to engage in one of chatting, messaging, ticket trading, or gaming and further enabling the users to view a location of the other users of the set group as portrayed on a seating chart of the venue; wherein the social user application utilizes the graphical depiction of the seating chart of the venue as an image file displayed on a screen of the mobile phone or smart phone of each of the users of the set group.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

Embodiments of the present disclosure generally relate to a system and method for communicating among users of a set group. More specifically, embodiments of the present invention relate to a system and method for communicating among users of a set group regarding common vacation locations, events, tickets, seats, or other related activities surrounding a particular venue, utilizing mobile communication devices.

As used herein, the term “venue” refers to, but is not limited to, any location or place of a particular event or activity. Exemplary venues may include any business, building, sporting field, concert hall, neighborhood, track/path (e.g., the roads traveled during a marathon), or the like, wherein persons may attend an event, concert, game, race, or other activity.

Also, as used herein, the term “multimedia data” refers to any type of data that may reasonably be construed as a media data type, including specifically, audio data (e.g., sound bites, music, or the like), visual data (e.g., photographs, graphics, videos, or the like), text data (e.g., as entered by a user from an input device), barcode data (e.g., as commonly found on tickets, labels, or the like), radio frequency identification (RFID) data, geographic and/or directional data (e.g., as reported from a Global Positioning System (GPS) or a preprogrammed routing source, often in the form of coordinates, or relationship positioning), purchase data (e.g., concession or merchandise purchase information), or the like. As understood by the embodiments disclosed herein, any discussion of one particular form of multimedia data shall be inclusive of any other type of multimedia data as defined above.

In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

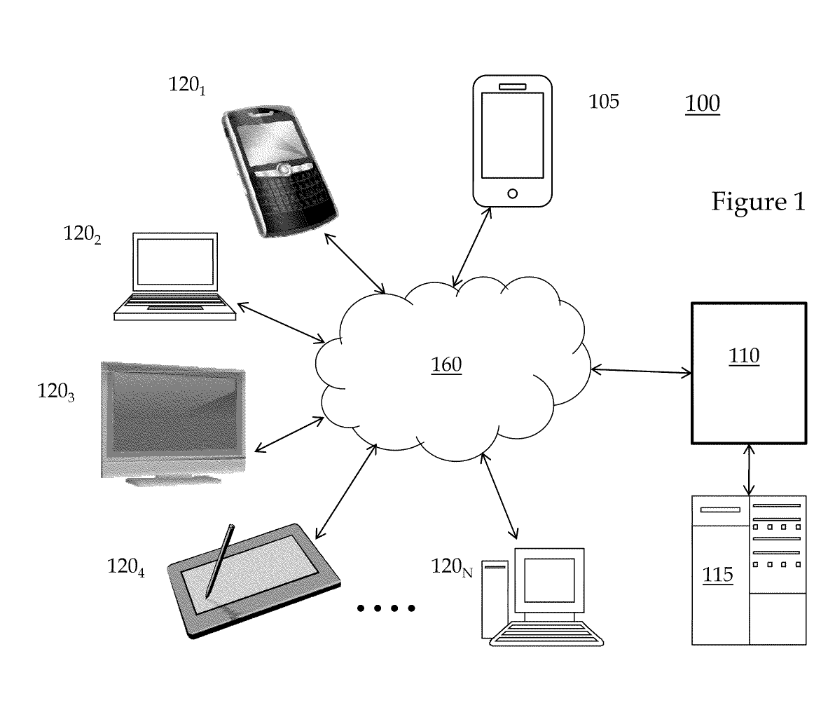

FIG. 1 depicts a basic system-level diagram of a system for communicating among users of a set group in accordance with one embodiment of the present invention. The system 100 generally comprises at least a first user 105 and secondary users 120₁ and 120₂, each in communication with an administrator 110 or host, generally hosting a central server 115 having a database, through a network 160. In accordance with one or more embodiments of the present invention, the network 160 generally comprises a global computer network, for example, the Internet.

Although FIG. 1 explicitly depicts five secondary users (labeled 120₁, 120₂, 120₃, 120₄ and 120_{N}), it should be appreciated that N represents any number of users feasible in accordance with embodiments of the present invention. For ease of reference, as used herein, each of the terms “second user” or “secondary user” may refer to any one or all of the users 120 within the system 100. Likewise, although FIG. 1 explicitly depicts only one first user 105, there may be more than one first user 105 in accordance with certain embodiments of the present invention. That is, in certain embodiments, multiple users may perform the same or similar functions as the first user 105. As understood by embodiments of the present invention, a user may include any person, business or entity, capable of participating in the system and methods disclosed herein.

The first user 105 generally has an interest in a particular event at a venue. The interest may be a real interest (e.g., the first user 105 has a ticket to the event, intends to watch the event, or the like) or a substantially provisional interest (e.g., looking to financially exploit the event, protest the event, or the like). Alternatively, the interest may be regarding an attribute of the event (e.g., the first user is a fan of a team in a particular sporting event). Additionally, the user may have an interest in an activity that is related to the event but occurs prior to or after the event at the venue.

In other embodiments, the first user 105 may have an interest in the venue itself. For example, the first user 105 may have a real interest in the venue (e.g., is looking to buy club seats, season tickets, advertising space, etc.). In another exemplary embodiment, the first user 105 may have an interest in an attribute of the venue (e.g., in a particular vendor location, the parking lot, etc.)

The secondary users may also possess the same or similar interests in the particular event at the venue as the first user 105. For example, the secondary users may also be attending the event, watching the event, attending pre or post event activities, or the like. In accordance with many embodiments of the present invention, a set group may be established by all users within the system 100 sharing a same or similar interest before, after or within a particular event at a venue.

In a basic exemplary embodiment, within the system 100, a first user 105 may be capable of transmitting data regarding the event to the administrator 110, using a computer device. The computer device in the context of this application may include, but is not limited to, any mobile device, such as an Apple iPhone, a Blackberry device, a smartphone, a Personal Data Assistant (PDA), a tablet (e.g., an Apple iPad), or the like. Similarly, a computer device may comprise a laptop, desktop, netbook, or may generally include a general purpose computer, as discussed below. In certain embodiments, the computer device may comprise an interactive television (e.g., a web TV, whereby the television is capable of interacting through a network with another party).

As explained above, the network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

Optionally, a third party commercial server (not shown) may be in communication with the system 100 through the network 160 to carry out certain features of embodiments of the present invention, as explained below. In accordance with embodiments of the present invention, such third party commercial servers may be administered by financial institutions (e.g., banks, credit card companies, or the like), advertisers (e.g., any third party offering banner ads or displayed offers), local merchants (e.g., providing information regarding an area around a venue), social networking sites (e.g., Facebook, MySpace, Twitter, or the like), global positioning system administrators, server farms (for third party hosting of the administrator described herein, or for cloud computing systems), or the like.

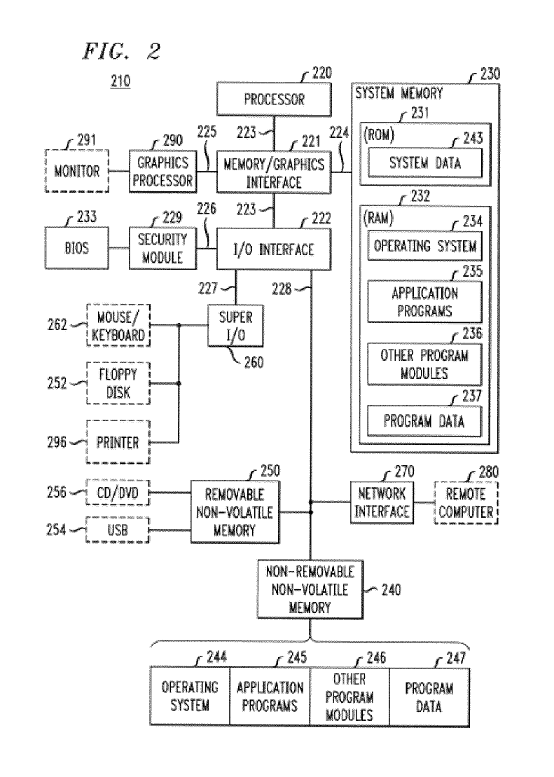

In accordance with one embodiment of the present invention, any of the administrator or users may comprise a general purpose computer, for example, as shown in the form of a computer 210 depicted in FIG. 2. As appreciated by embodiments of the present invention, more practical devices, such as mobile devices, mobile telephones, or the like, are likely to be utilized than a general computer 210 for embodiments of the present invention. However, it is also appreciated there is a significant similarly in core components between a mobile device and a general computer 210. The following components are described for exemplary purposes only, and each component's mobile equivalent is also contemplated within embodiments of the present invention.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, an internal computer network, dedicated server networks, and the like.

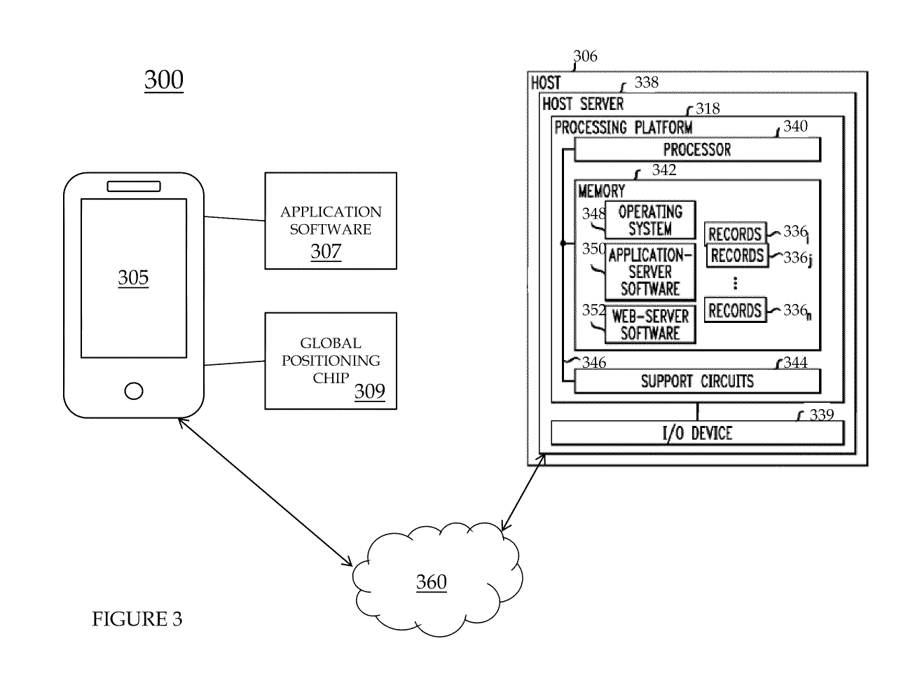

FIG. 3 depicts a system of communication between a user and an administrator in accordance with one embodiment of the present invention. As shown in the Figure, a user 305 generally comprises a computer device, for example, a mobile phone or a smart phone. The user 305 may also generally comprise application software 307 and a global positioning chip 309. Other I/O components, which are common to computer devices, mobile phones and smart phones may also be provided but are not described in detail herein as they are well known in the industry.

As shown, the user 305 may include application software 307 that is operable to interact through the network 360 with the administrator or host 306 to allow the user to engage in the functionality as disclosed herein. Generally, the application software 307 may be obtained from any source, for example, through a third party website or application. In one specific example, the third party application for allowing the user 305 to download the application software 307 may be the application made commercially by Apple, Inc., under its “iTunes” trademark. Other similar means of obtaining the application software 307 are readily known in the industry.

In alternative embodiments, the application software 307 may be stored by the administrator and accessed through the network 360 when used by the user 305. For example, the application software 307 may be available as streaming information, whereby a web browser (not shown) or similar program is utilized to communicate with the administrator 306 and engage in the functionality disclosed herein.

The user 305 may also comprise a global positioning chip 309 and accompanying software, to enable the user 305 to obtain an accurate physical location of the user, or at least the user's computer device, when requested. The location information obtained through the global positioning chip 309, through a global positioning system (not shown), may be transmitted to the administrator 306 to facilitate certain functions of the system described herein.

The network 360 may be similar to the network 160 as shown in FIG. 1 above, and may comprise any type of computer network or data network suitable for embodiments of the present invention.

The administrator or host 306 may include one or more servers, including a host server 338. The host server 338 may be deployed in one or more general or specialty purpose computers, personal computers, mainframes, minicomputers, server-type computers, such as the general purpose computer shown in FIG. 2, and/or any a processor-based platform that operates on any suitable operating system, such as Microsoft® Windows® and/or Linux; and that is capable of executing software.

The host server 338 may include a large number of elements; most of which are not shown in FIG. 3 for simplicity of exposition. The elements of host server 338 may be formed in a single unitary device and concentrated on a single server, client, peer or other type node. Alternatively, the elements of the host server 338 may be formed from two or more separate devices, and as such, may be distributed among a number of server, client, peer or other type nodes.

The host server 338 may be deployed in accordance with the scale-up and/or scale-out approaches. Using the scale-up approach, the host server 338 may increase its processing power, amount of memory and number of networkable connections by utilizing a symmetrical, multi-processor architecture so as to provide additional capacity. A benefit of this scale-up approach is that such approach provides for simplified configuration and management as compared to the scale-out approach. Using the scale-out approach, the host server 338 may increase its processing power, amount of memory and number of networkable connections by incrementally adding and/or removing capacity as needed, balancing workload across multiple processors, multiple servers, dedicating specific processors and/or servers for performing specific tasks, using physical or logical servers (e.g., a multi-node cluster approach), etc.

As shown, the host server 338 includes one or more processing units (collectively “processor”) 340, memory 342, supports circuits 344 and bus 346. The processor 340 may be one or more conventional processors, microprocessors, multi-core processors, microcontrollers and the like.

The bus 346 provides for transmissions of digital information among the processor 340, memory 342 and support circuits 344 and other (not shown) portions of the host server 338. The support circuits 344 facilitate operation of the processor 340, and may include well-known circuitry or circuits, including, for example, one or more input/output I/O interfaces; one or more NIUs; cache; clock circuits; power supplies and the like.

The I/O interface provides an interface to control the transmissions of digital information among (shown and not shown) components of host server 338. In addition, the I/O interface provides an interface to control the transmissions of digital information among I/O devices 339 associated with or otherwise attached to the host server 138. The I/O devices 339 may be embodied as any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) a pointing device, such as a mouse, joystick, trackball, touchpad, pointing stick, light pen, head pointer, soap mouse, eye tracking devices, digitizing tablet and stylus, data glove that translates the user's movements to computer gestures; (vii) a key-in device, such as a keyboard or a touchpad, (viii) and the like.

The NIUs facilitate exchange (e.g., sending and/or receiving) of content. Accordingly, the NIUs may be adapted for communicating over terrestrial wireless, satellite, and/or wireline media.

The memory 342 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like. The memory 324 may store and/or receive requests from the processor 340 to execute various software packages, such as operating system 348, application-server software 350 and web-server software 352.

Additionally, the memory 342 may store and/or receive requests from the processor 340 to obtain the records 336ᵢ-336ₙ(e.g., copies thereof). As above, each of the records 136ᵢ-136ₙ may be stored as or in a single file or a plurality of files, and may be structured as text, a table, a database, a distributed hashtable, a distributed concurrent object store, a document formed using a markup or markup-like language, and the like. The records 136ᵢ-136ₙ may be stored, for example, using a Microsoft SQL Server and accessible through an ODBC connection.

Like the records 136ᵢ-136ₙ, the memory 342 may store and/or receive requests from the processor 340 to obtain operands, operators, dimensional values, configurations, and other data that are used by the various software packages to control the operation of and/or to facilitate performing the functions of the host server 338 and/or the host 306.

The application-server software 350, when executed by the processor 340, is operable to (i) communicate with the user 305, via the network 360, to obtain the information regarding the user 305, the venue (not shown), the event (not shown) or the like, and store it as record 336; and facilitate the creation of a virtual set group of users based on the information stored in record 336 associated with the user 305. In addition, the application-server software 350, when executed by the processor 340, is operable to enable interaction between the users within a virtual set group as described herein.

The web-server software 352, which may be optional, when executed by the processor 340, is operable provide on one or more network or web-accessible pages to allow the user 305 to access information stored on the host server 338. For example, web-server software 352 may provide a data portal, having a graphical user interface, through which a user 305 may access the application-server software 350 and the functionality thereof. In such an embodiment, the application software 307 of the user 305 may only comprise a web browser or similar application for viewing the content of the web-server software 352 through the network 360.

It should be appreciated by embodiments of the present invention, although only one user 305 is shown, other users may access the administrator 306 in a similar fashion, such that a plurality of users can co-exist in communication with the administrator 306 through the network 360.

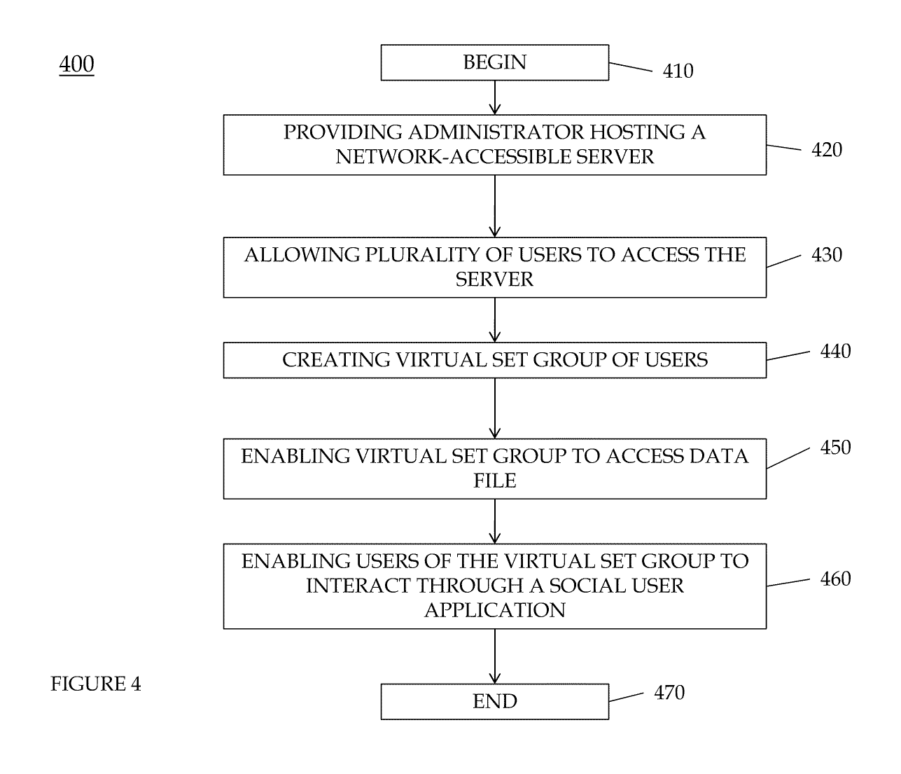

FIG. 4 depicts a flowchart of a method for communicating among users of a set group in accordance with one embodiment of the present invention. The method 400 may be carried out within a system architecture similar to system 100 of FIG. 1 or system 300 of FIG. 3. However, it is appreciated by embodiments of the present invention, the proposed commercial embodiments may be carried out within other system architectures as well. The method 400 beings at step 410.

At step 420, an administrator hosting a network-accessible server is provided. As described hereinabove, the administrator may generally comprise any individual or entity responsible for establishing the systems disclosed herein, and implanting the functions and methods also disclosed herein. In many embodiments, the network accessible server is similar to the server 338 as disclosed in FIG. 3.

At step 430, a plurality of users are able to access the server. As discussed herein, generally a user may comprise a personal computer or a mobile device (e.g., a cell phone, smartphone, tablet, laptop or other handheld computing device). The user may access the server by any of a wired or wireless connection, as described above through a network.

In many embodiments, prior to accessing the server, the users may each create an account and/or a profile for storing on the server. For example, during a user's first experience accessing the server, the user may be able to create an account by providing personal, demographic, geographic, or other information regarding the user, as is common in many social networking systems. In certain embodiments, the user may also provide information regarding frequently visited venues, favorite sports teams, or other personal information, specific to aspects of embodiments of the present invention. By savings such information to a user's profile or account, the user may not have to provide such information in future connections to the server, to preserve time and efforts by the user when utilizing certain embodiments of the present invention.

At step 440, the administrator may facilitate the creation of virtual set groups of users. In one embodiment, based on information provided by the users upon accessing the server, the administrator may create virtual set groups, i.e. groups of users having a common goal, interest, location, etc. Often, the virtual set groups are created by the administrator by evaluating a common interest and/or location surrounding a particular venue and/or event. For example, a virtual set group may be created amongst a group of users who are fans of a particular sports team and are located within 10 miles of the stadium on the evening of a game. In many embodiments, the virtual set groups may be treated as virtual online communities, similar to those occasionally utilized in general social networking systems to introduce users having common interests to one another.

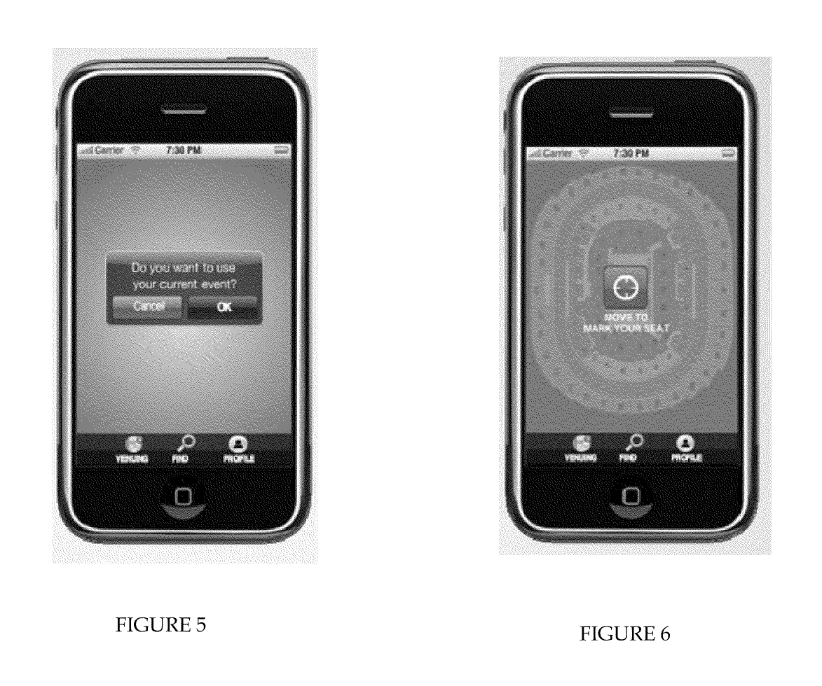

In many embodiments, a virtual set group of users is created around a particular venue or event, and is based upon user selection or location. For example, FIG. 5 depicts a user's computer device showing an inquiry provided by the application software to facilitate the communication among users of a set group in accordance with one embodiment of the present invention. As shown in the Figure, when the user first accesses the server, the user may be asked, based on GPS information in the user's mobile device, or based upon selections made by the user, whether the user wishes to utilize a particular venue or event as the basis for joining a virtual set group. In addition thereto, the user may be able to search for or browse existing virtual set groups to join, or in an alternative embodiment, create a virtual set group for other users to join.

In many embodiments, where the creation of the virtual set group is based upon location, the location of each user may be obtained using any suitable data acquisition means. For example, in one embodiment, a user's location may be obtained through manual entry of a physical address (e.g., a building, a street address, a town, or the like). In another embodiment, a user's location may be obtained through a location-based utility on the user's mobile device (e.g., a mobile device's GPS, triangulation positioning from mobile communication towers, triangulation via WiFi or WLAN, or the like).

Upon receipt of location information, and upon validation of such information by either user inquiry, GPS proximity, or the like, the user may be placed in communication with any number of secondary users at or near the same location, in a virtual set group. For example, if a first user's location is obtained and validated as being at Madison Square Garden in New York City, the first user may be put into a set group of any other users who are also in or around Madison Square Garden. By limiting the set groups to users in the same or proximate locations, communication and features within the system available to the set group, would be protected from third parties attempting to cause confusion or miscommunication who are not at that location.

In alternative embodiments, users may be placed into set groups based on any number of characteristics or attributes. For example, at a sporting event, users who are actually at the event may also be in communication with pre-screened experts or other users, who wish to pass along information regarding the event, but whose physical location may be nowhere near the actual venue hosting the event. Similarly, the virtual set groups may be focused on a very specific common characteristic or attribute, for example, a virtual set group may be based upon users who are fans of a particular player on a particular team.

At step 450, based upon the nature of the virtual set group, the administrator may enable the virtual set group to access a data file. In many embodiments, the data file comprises multimedia data, including video, still image, audio, or the like. In one embodiment, the data file comprises a graphic depiction of the venue about which the virtual set group was created. In certain embodiments, the data file comprises a seating chart or layout of the venue.

In accordance with many embodiments of the present invention, the data file may either be stored on the server or on the user's mobile device or personal computer. Where the data file is stored on the server, upon access to the server and entry into a virtual set group, the user may download or otherwise retrieve the data file. Where the data file is stored on the user's device, the data file may be retrieved through instructions by the application software on the user's device.

In many embodiments, once the data file is obtained, it may be displayed on the screen of the user's device. Optionally, as shown in FIG. 6, a user may receive a specific location-based inquiry overlaid on the data file. As shown in the Figure, with a seating chart of a particular venue in the background, the user may pinpoint a particular seat or area of the venue where the user is currently located or where the user possesses tickets to seats within the venue. In some embodiments, the GPS information from the user's mobile device may facilitate the location pinpointing.

At step 460, the administrator enables the users of the virtual set group to interact through a social user application, in accordance with embodiments of the present invention. Generally, embodiments of the present invention provide a social user application allowing users to connect with other users at a venue, and by using location-based technologies, developments in mobile applications, text-chat and photo-blogging features, and SMS or MMS features in a mobile device, embodiments of the present invention create an entertainment rich environment wherein users can chat about an event—at the event, trade information, merchandise and tickets, and make plans for before or after the event.

In certain embodiments, each user may be authorized as either an active or passive participant within the virtual set group, or may even be unauthorized to enter a particular virtual set group. In such embodiments, if the user is authorized as an active participant, the user may be able to create text and multimedia message for transmission to other clients within the virtual set group, or alternatively, may have access to any user applications provided within the virtual set group. If a user is authorized as a passive participant, the user may be able to review and monitor text and multimedia transmissions from other user, but may have not the ability to create messages. In addition, a passive participant may be provided limited access to other user applications provided within the virtual set group.

The interactive features within a virtual set group may vary greatly depending on the nature of the virtual set group and/or the venue/event about which the virtual set group was created. In many embodiments, the interactive features may include: chat, ticket trading, games, or the like. Other features may include any features suitable for embodiments of the present invention, including, but not limited to, features found on social networking sites, such as multi-media sharing, data posting, and status updates.

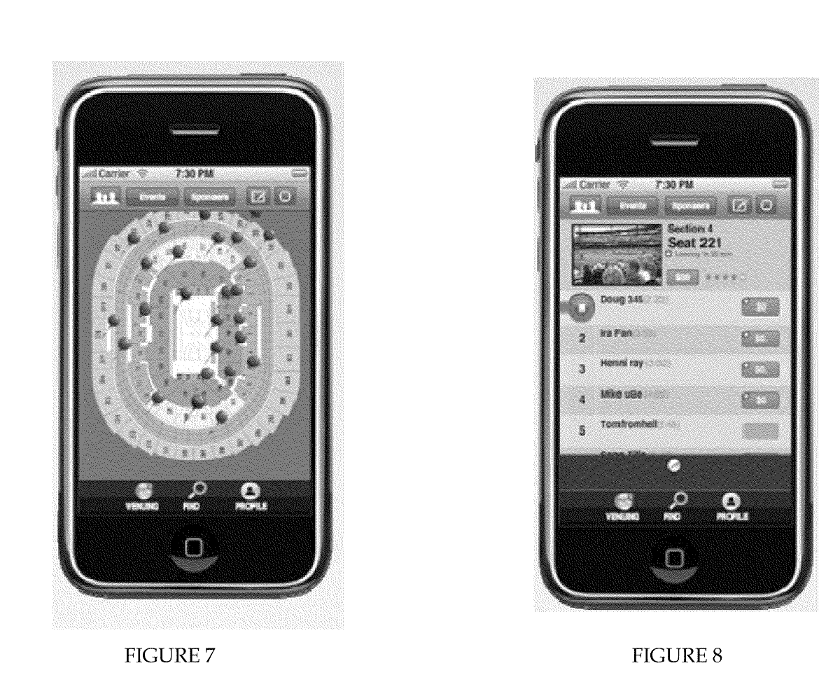

In many embodiments, as shown in FIG. 7, users may be able to see the positioning of each other user as overlaid on the data file. By providing the location of each of the users within a virtual set group, users may be able to locate one another in a physical setting if desired.

In certain embodiments of the present invention, users within a virtual set group may be able to utilize a ticket-trading or “second sale” feature, for example, as shown in FIG. 8. In such a feature, users in possession of good tickets or good seats at a particular event, that choose to leave the event early (for whatever reasons) may be able to transfer or sell their tickets and/or seats to someone who may be seated in undesirable seats within the venue for a portion of the event (e.g., the second half of a football game, the last four innings of a baseball game, or the like). A more detailed description of such type of feature is disclosed in commonly owned U.S. patent application Ser. No. 12/378,791, filed Feb. 20, 2009, entitled “Ticket Trading Method,” the disclosure of which is incorporated by reference herein in its entirety.

As shown in FIG. 8, during the use of a ticket-trading feature, images of the view from the seats offered for sale, as well as a proposed price, may be provided through the social user application. In addition, in optional embodiments, features such as auctions, initiations to receive offers to buy seats, etc. may also be implemented through the ticket-trading application.

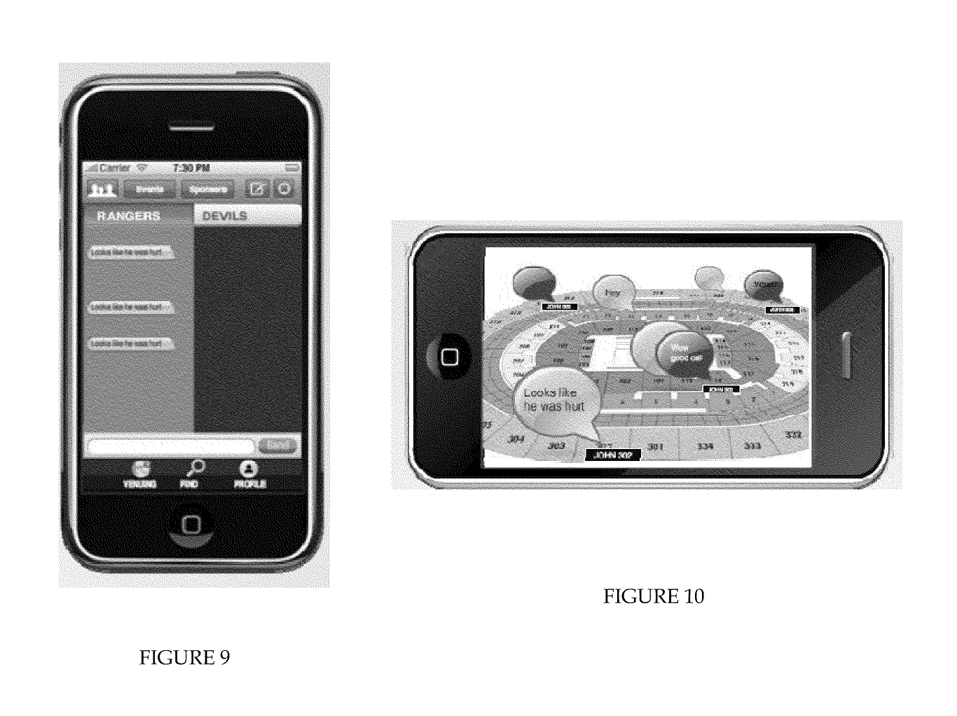

In further embodiments, users within a virtual set group may have a common location at a venue, but may have opposing interests therein. For example, in certain embodiments, some users within the virtual set group may be a fan of a first team playing at a venue, while the other users within the virtual set group may fans of second team playing the first team at the venue. As shown in FIG. 9, in one exemplary embodiment, interest-based chat groups may be established within the virtual set group—pairing users of each team against one another in a chatroom. Thus, the ability to speak with or virtually taunt fans of an opposing team may be done. In addition to chatting, other multimedia functions may be provided as well.

In yet further embodiments of the present invention, users within a virtual set group may share information with one another, as during a chat conversation, while viewing each of the chat messages overlaid on a data file reflecting each user's position within the venue, as shown in FIG. 10. In many instances, the positioning may be shown on each user's device slightly different, in that the point of view of the venue may be shown from each respective user's actual point of view.

Other features of embodiments of the present invention may include: setting up group discussion boards, broadcasting messages (either text of multi-media based) to one or all users in the set group, set up trivia or game sets, friend/user locators, or posting pictures, images, photographs, or videos from the event for one or more of the users within a set group. In other embodiments, certain topics for discussion may be preprogrammed into a user's application, such as: notifications for tailgating, post-event parties/activities, starting a wave (e.g., at a sporting event), or the like.

In other embodiments, users within a virtual set group may be able to search for friends or acquaintances who may be at the same event, by tying the system of the present invention into popular social networking sites, such as Facebook, MySpace, Twitter, LinkedIn, or the like. By enabling communication between the system of embodiments of the present invention and such third party sites, users may be able to know which “friends” are attending a particular event, and where “friends” are sitting at the event, and may optionally utilize images or other data from the social networking sites to enhance the multi-media capabilities of embodiments of the present invention. Such third party sites may also be able to provide information regarding the event or venue, for example, reviews of particular seats, restaurants/vendors, performance, etc. of entities or locations within the venue.

In additional embodiments of the present invention, a venue administrator of the venue itself may be a user within the system. In such types of embodiments, the venue administrator may have a venue administrator panel or portal through which the venue administrator can communicate with a particular set of users in a virtual set group. In one embodiment, the venue administrator may be able to stream messages across a screen of the device of each user, whereby such messages may include promotions, advertisements, notifications, promotional codes for discounts at stores or vendors within the venue, or the like.

In another embodiment, whereby the venue administrator is a user within the system, other users of a virtual set group may be able to communicate directly with the venue for various purposes. For example, through the application users of a virtual set group may be able to order food, products, or services from the venue. Optionally, the users may be able to have such goods or services delivered to the user's seat based upon information provided by the user.

The method 400 ends at step 470.

It should be appreciated by embodiments of the present invention, however, that the steps associated with method 400 are not limited to those specifically described, or the order in which they are presented. Rather, embodiments of the present invention contemplate such methods are not limited by any number of features utilized by a user of a virtual set group, or by any temporal activities regarding the event (e.g., the users of the set group may remain in such set group until all such users exit the group—thus, preserving the ability for users to remain in contact with one another for discussions, challenges or the like, long after the event at the venue has concluded). Other optional and alternative embodiments are described below.

In some embodiments of the present invention, the administrator may charge a user access fee, in either a one-time or per-use amount. For example, in one embodiment of the present invention, the system may be designed to interact with users in possession of an Apple iPhone. In such instance, users may be required to purchase the “application” in order to utilize the systems and features disclosed herein. In an alternative embodiment, users may be allowed to access features of embodiments of the present invention, and will be billed at a subsequent date for the amount of data transferred to and from such user. Alternative embodiments contemplate utilizing any known method for acquiring fees for the sale or license of software application utilized by mobile devices, as known in the industry.

In other embodiments, revenue streams may be generated by the administrator for allowing third party advertisements or sponsorships within features of the system. In one embodiments, such third party advertisements may come in the form of ad banner sponsorships (either fixed fee, cost per click (CPC) or cost per mille (CPM)-based billing), text sponsorships (either MMS or SMS-type messages), location-based (geo-targeted) advertising (e.g., “Come to Charlie's Pub on 6th Ave after the Game for $2.00 Draft Beer!”), or email sponsorship to users of the system. In other embodiments, any known advertising through mobile devices may be utilized for purposes of increasing revenue to the administrator of embodiments of the present invention.

In additional embodiments, the advertisements described herein may be targeted to users based on personal, demographic and/or geographic information provided by the user within the system. For example, where the user indicates to the system that he/she is from out-of-state, but is in town for a particular venue/event, the system may be able to target particular advertisements regarding hotels, transportation, or other services a tourist may be interested in receiving. Similarly, advertisements and messages may be targeted based on location within the venue itself. For example, users sitting on a particular side of a field in a stadium may receive information regarding a vendor on that side of the stadium, whereas users on the other side of the stadium receive a different message altogether.

In further embodiments, the concept of “cross-venue” communications may exist. For example, it may be desirable to tie users from first venue in a virtual set group of users from a second venue (e.g., during a American League East pennant race, users from Fenway Park in Boston may be in a virtual set group with users at Yankee Stadium in New York). In such embodiments, the data file may comprise high level graphical depictions of each of the stadiums (i.e., two or more), and streaming messages coming from each stadium.

In yet further embodiments of the present invention, a user comprising an interactive television may be able to utilize the live streaming television of a particular game or event as the data file described herein. Accordingly, although the user may watch the game as televised, the features and interactive elements of embodiments described herein may be overlaid on the screen, similar to how still images are utilized in FIGS. 7-10. In one embodiment, whereby the television production company is a third party to the system, locations of users within a virtual set group at the venue may appear depending on the camera angles of the television production company while recording the event.

While the foregoing is directed to embodiments of the present invention, other and further embodiments of the invention may be devised without departing from the basic scope thereof. Furthermore, whereas the multitude of embodiments disclosed herein each provides a variety of elements within each embodiment, it should be appreciated any combination of elements from any combination of embodiments is well within the scope of further embodiments of the present invention.

What is claimed is:

1. A system for communicating among members of a set group comprising:
an administrator hosting a computer network-accessible server;
a plurality of users, each user comprising a computer device capable of accessing the server through the computer network;
a set of executable instructions stored on the server, the instructions comprising steps in connection with creating a virtual set group of users from the plurality of users based on a common interest in a real event at a venue;
a data file comprising a graphic depiction of the venue, stored on the server, and downloadable to the computer device of each of the users; and
at least one social user application, accessible by each of the users of the virtual set group, enabling the users of the virtual set group to interact;
wherein the social user application utilizes the data file as an image file displayed on a screen of the computer device of each of the users of the set group.

2. The system of claim 1, wherein the computer device of each of the users comprises one of a mobile phone, a smart phone, a laptop, a netbook, a personal computer, a tablet or an interactive TV.

3. The system of claim 1, wherein the computer device of each of the users comprises a global positioning chip capable of transmitting each user's location to the administrator.

4. The system of claim 1, wherein the venue comprises one of a business, building, arena, stadium, rink, sporting field, concert hall, neighborhood, track or path.

5. The system of claim 1, wherein the real event comprises a scheduled occurrence having a specific start time and a plurality of people in attendance.

6. The system of claim 5, wherein the scheduled occurrence comprises one of a sporting event, a concert, a dramatic production, a conference, or a rally.

7. The system of claim 1, wherein creating a virtual set group of users from the plurality of users based on a common interest in a real event at a venue further comprises obtaining information from each of the plurality of users regarding location, subjective interests, or intentions of pre- or post-event activities.

8. The system of claim 1, wherein the graphic depiction of the venue comprises a seating chart of the venue.

9. The system of claim 1, wherein enabling users of the virtual set group to interact comprises one of chatting, messaging, ticket trading, or gaming.

10. The system of claim 9, wherein enabling the users to interact further comprises viewing a location of the other users of the set group as portrayed on a seating chart of the venue.

11. A method of communicating among members of a set group comprising:
providing a administrator for hosting a computer network-accessible server, the server comprising a memory for storing executable instructions in connection with creating a virtual set group of users from a plurality of users;
allowing the plurality of users, each user comprising a computer device, to access the server through the computer network;
creating the virtual set group of users from the plurality of users based on a common interest in a real event at a venue;
enabling each of the virtual set group of users to download a data file from the server, the data file comprising a graphic depiction of the venue; and
enabling the users of the virtual set group to interact through at least one social user application, accessible by each of the users of the virtual set group;
wherein the social user application utilizes the data file as an image file displayed on a screen of the computer device of each of the users of the set group.

12. The method of claim 11, wherein the computer device of each of the users comprises one of a mobile phone, a smart phone, a laptop, a netbook, a personal computer, a tablet or an interactive TV.

13. The method of claim 11, wherein the computer device of each of the users comprises a global positioning chip capable of transmitting each user's location to the administrator.

14. The method of claim 11, wherein the venue comprises one of a business, building, arena, stadium, rink, sporting field, concert hall, neighborhood, track or path.

15. The method of claim 11, wherein the scheduled occurrence comprises one of a sporting event, a concert, a dramatic production, a conference, or a rally.

16. The method of claim 11, wherein creating a virtual set group of users from the plurality of users based on a common interest in a real event at a venue further comprises obtaining information from each of the plurality of users regarding location, subjective interests, or intentions of pre- or post-event activities.

17. The method of claim 11, wherein the graphic depiction of the venue comprises a seating chart of the venue.

18. The method of claim 11, wherein enabling users of the virtual set group to interact comprises one of chatting, messaging, ticket trading, or gaming.

19. The method of claim 18, wherein enabling the users to interact further comprises viewing a location of the other users of the set group as portrayed on a seating chart of the venue.

20. A system for communicating among members of a set group comprising:
an administrator hosting a computer network-accessible server;
a plurality of users, each user comprising one of a mobile phone or a smart phone, capable of accessing the server through the computer network and comprising a global positioning chip capable of transmitting each user's location to the administrator;
a set of executable instructions stored on the server, the instructions comprising steps in connection with creating a virtual set group of users from the plurality of users based on a common interest in a real event at a venue, including obtaining information from each of the plurality of users regarding location, subjective interests, or intentions of pre- or post-event activities;
a data file comprising a graphical depiction of a seating chart of the venue, stored on the server, and downloadable to either the mobile phone or the smart phone of each of the users; and
at least one social user application, accessible by each of the users of the virtual set group, enabling the users of the virtual set group to engage in one of chatting, messaging, ticket trading, or gaming and further enabling the users to view a location of the other users of the set group as portrayed on a seating chart of the venue;
wherein the social user application utilizes the graphical depiction of the seating chart of the venue as an image file displayed on a screen of the mobile phone or smart phone of each of the users of the set group.
